(19) United States
(12) Patent Application Publication
(10) Pub. No.: US 2002/0131713 A1
(43) Pub. Date: Sep. 19, 2002

(54) Tapered fiber holder

(76) Inventors: Yihlih Peng, Fremont, CA (US); Warren Lewis, Sunnyvale, CA (US)

Correspondence Address: LACASSE & ASSOCIATES, LLC, 1725 DUKE STREET, SUITE 650, ALEXANDRIA, VA, 22314, US

(21) Appl. No.: 09/765,382

(22) Filed: Jan. 22, 2001

(51) Int. Cl. G02B 6/26

(52) U.S. Cl. 385/43; 385/51

(57) ABSTRACT

The invention provides an optical device wherein a tapered optical fiber is supported on a substrate which is at least partially coated with a polymeric material for protecting the tapered optical fiber during an impact therewith. A spacer is provided for suspending the tapered optical fiber over the at least partially coated substrate. The spacer is adjacent to non-tapered portions of the tapered optical fiber. Advantageously, an adhesive is used as the spacer so as to secure the tapered optical fiber in a predetermined position.

### FIELD OF THE INVENTION

The present invention relates generally to fiber optics and in particular to a holder for tapered fibers.

### BACKGROUND OF THE INVENTION

Over the last 15 years, a number of fiber optic components and devices such as couplers, attenuators, wavelength division multiplexers/demultiplexers, connectors, filters, switches, fiber-pigtailed semiconductor lasers, isolators, etc., have been developed for use in fiber optic communication systems, sensors and instrumentation. In nearly all of these applications employing fiber optic components or devices, design-specific mounting fixtures are utilized to precisely align, position or secure optical fibers or elements within such optical fiber components or devices. In most of these applications, it is common for such mounting fixtures to be formed of a fused silica material because its low coefficient of thermal expansion closely matches that of the optical fibers and other optical components or devices. In this respect, maintaining the stability and relative position of optical fibers, components or devices, through the correct choice of materials, is particularly critical.

A fiber optic coupler is used in optical fiber interconnection arrangements to couple electromagnetic waves from one of two or more optical fibers to another optical fiber in the group. A fused fiber optic coupler consists of two or more adjacent optical fibers that are joined by heating to form a common region. It is formed by fusing and tapering two or more optical fibers together. The fabrication usually involves aligning principle axes of two or more optical fibers after removing a portion of a protective jacket on the optical fibers. The fibers are positioned such that their parts to be fused are in contact with each other. The fibers are then heated at the parts to be fused in a manner such that the cladding softens, the spacing between the fiber cores is reduced, and the two fibers are fused together. The fibers thus fused together are fixed to form a coupling element by cooling to room temperature. Optical coupling is the phenomenon, which transfers transmitted light from one fiber to another fiber in this common region.

When two dissimilar materials are joined together and subjected to heat or cool cycles, the differences in their thermal expansion coefficients can induce large stresses. Depending on the exact geometry and material distribution, the transient stress field may be quite complex. Stress concentration points may easily damage fragile microstructures Even in a simple layout such as two thin fibers adhering to each other, temperature cycling may cause the bi-material strip to curl and flex, accelerating fatigue of the system.

However, even if fibers of the same material are fused together to form a coupler, the resulting coupling region is fragile and care must be taken to avoid fracture of the fused fiber.

Further, fiber optic couplers are very sensitive to environmental influences because the optical material of which the optical fibers are made is very fragile. In addition, the coupling region is not provided with a jacket so adverse environments influence the quality of the optical material of the fiber optic coupler and/or the signals transmitted through the fiber optic coupler. A problem with fused fiber optic couplers is latent failure of the coupler fiber or fibers due to stresses induced on the fiber, such as pulls or flexure on the fiber from outside of the coupler package. The fused and tapered portions of the coupler where the transfer of optical power takes place is structurally weak and sensitive to such abuse, in addition to changes in environmental conditions.

Hence, in the field of fiber-optic systems a major difficulty arises from the fact that optical fibers are relatively fragile structures, which may be easily broken when subjected to stress. It has long been recognized by those skilled in the art that it would be highly desirable to rigidly support an optical fiber so that it can be more easily manipulated.

There is a need for an arrangement for preserving the optical characteristics of a fiber optic device by physically protecting the fiber optic device from damage caused by environmental effects, for example shock and/or vibration.

Optical fibers, components and devices are typically secured to a base plate or substrate with an epoxy material. Epoxy adhesives are widely used because they are inexpensive, easy to use and in many instances, readily cured.

Prior art packaging techniques which have been used to protect the fiber optic coupler from such deleterious influences include the use of quartz glass tubes as protective covering and as a support for the coupled region of a fiber optic coupler. For example, U.S. Pat. No. 5,384,875 discloses such a prior art fiber optic coupler package. In such an arrangement, the coupled region is typically placed within a central open portion of a slotted quartz glass tube and epoxy is applied at the ends of the tube to secure the optical fibers extending therefrom and the coupled region to the tube. However, difficulties arise in environments in which substantial shock or vibration occurs because of the resulting material movements of the coupled region of the fiber optic coupler suspended in the central open portion of the tube.

In part, the above difficulties have been overcome by placing the fibers within the slotted glass tube and then heating the mid-region of the tube until it collapses about the fiber by stretching the tube to reduce the diameter thereof. This method places the tube in direct contact with the optical fibers and the coupled region of the fiber optic coupler, thereby providing rigid support to the coupled region. However, this places additional stress on the coupled region causing losses and other difficulties.

U.S. Pat. No. 5,822,482 discloses a method of packaging a fiber optic coupler wherein a protective body is provided having a receiving space therein. The coupler is positioned within this receiving space and the coupler ends are affixed to the protective body.

Techniques such as those discussed above for packaging fiber optic couplers leave much to be desired for protecting the coupler from environmental influences, such as shock and/or vibrations. This protection is especially lacking where the fused fiber optical components and the packaging thereof are often subjected to pulls, flexure, and/or to vibrations or impacts of controlled magnitudes. Thus, it has been observed that the failure or breakage rate of fiber optic components encased in such manners presents a severe limitation to the use of such packaged fiber optic components in communication applications.

It is an object of this invention to improve the reliability of tapered or fused fiber optical components.

It is a further object of this invention to improve a protection of the tapered or fused region of fiber optical devices from being damaged by stresses, such as mechanical shock and/or vibrations.

### SUMMARY OF THE INVENTION

In accordance with the invention there is provided an optical device comprising: (a) a tapered optical fiber; and (b) a substrate for supporting said optical fiber, wherein a surface of the substrate has an at least partial coating with a material for protecting the tapered optical fiber during an impact therewith.

In accordance with the invention there is further provided a support for a tapered optical fiber comprising: a stiff substrate for supporting the tapered optical fiber, wherein a surface of the substrate has an at least partial coating with a polymeric material for protecting a tapered optical fiber during an impact therewith when the tapered optical fiber is suspended over the at least partially coated surface of the substrate.

In accordance with another aspect of the invention, there is provided an optical device comprising: (a) a tapered optical fiber; (b) a substrate for supporting said optical fiber, wherein a surface of the substrate has an at least partial coating with a polymeric material for protecting the tapered optical fiber during an impact therewith; and (c) a spacer for suspending the tapered optical fiber over the at least partially coated substrate.

### BRIEF DESCRIPTION OF THE DRAWINGS

Exemplary embodiments of the invention will now be described in conjunction with the drawings in which:

FIG. 1a shows a prior art fused fiber tapered coupler;

FIG. 1b shows yet another assembly of a prior art fused fiber optic coupler;

FIG. 2a shows an oblique view of an optical device for supporting a tapered fiber in accordance with the invention;

FIG. 2b shows a schematic cross sectional side view of the optical device shown in FIG. 2a;

FIG. 2c shows an oblique view of the optical device illustrated in FIG. 2a in accordance with another embodiment having a partial surface coating;

FIG. 3 shows an oblique view of another optical device in accordance with the invention wherein a tapered fiber is supported in a receiving space of a support material; and

FIG. 4 presents a schematic side view of the optical device shown in FIG. 3.

### DETAILED DESCRIPTION OF PREFERRED EMBODIMENTS

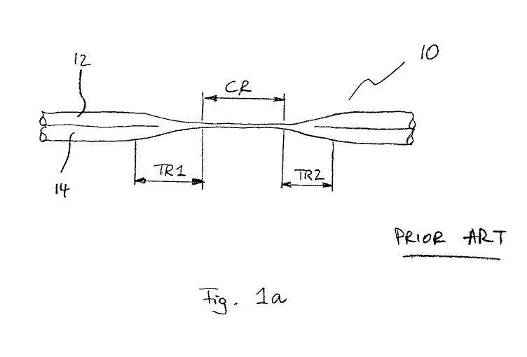

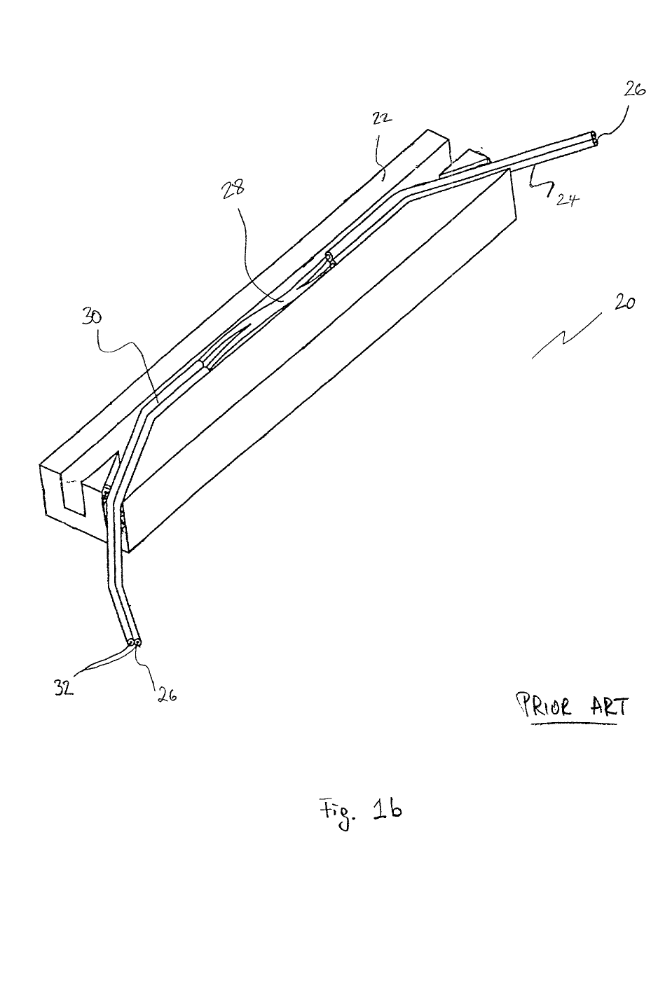

Turning now to FIG. 1a a prior art fiber optic cylindrical coupler 10 is shown that is generally comprised of two fibers 12 and 14 that are fused or melted together along a portion of their length having tapered regions TR1 and TR2 and a constant diameter coupling region CR. The coupler is formed in two distinct sequences. First, after stripping away the protective jacket, two fibers which have not had their size or geometry altered by heating, etching, or other means, are fused or melted together along the bared portion of their length. Then the fused region is heated again and stretched differentially to form the cylindrical coupling region and the adjacent tapers. During the fusion step the molten fiber cladding flows allowing the cores to move closer together.

FIG. 1b presents another prior art fused fiber optic coupler assembly 20 as described in U.S. Pat. No. 5,822,482. The fiber optic coupler assembly 20 creates slack zones of fiber inside the coupler package 22 such that forces exerted externally on the optical fibers 26 are dissipated by removing the slack in the zone. Thus the forces are kept from reaching the most vulnerable region, the coupled region 28, of the fiber optic coupler.

The fiber optic coupler assembly 20 is composed of a coupler package 22 and a fiber optic coupler 24. Fiber optic coupler 24 includes optical fiber 26 having a jacket 30 thereon about fiber portions 32. A portion of the jacket 30 is removed from a section of the optical fibers such that a coupled region 28 is formed by a fusing and tapering process. Such process may include any one of a number of techniques for creating the coupled region 28 known to those skilled in the art; the coupled region 28 allowing for coupling of optical power.

As discussed above, the coupled region 28 is fragile and as a result of mechanical stresses induced on this coupled region, cracks may develop in the fiber that eventually lead to a breakage of the fiber. In accordance with an embodiment of the present invention a holder is provided that reduces the mechanical stress on the tapered fiber region so that latent failures of devices containing tapered optical fiber components are substantially reduced.

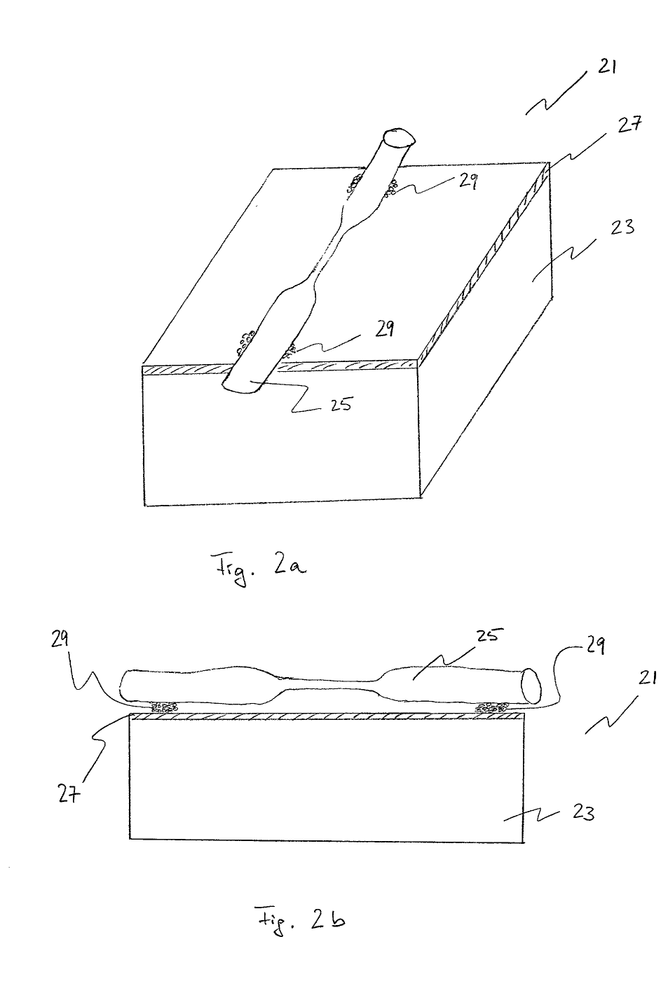

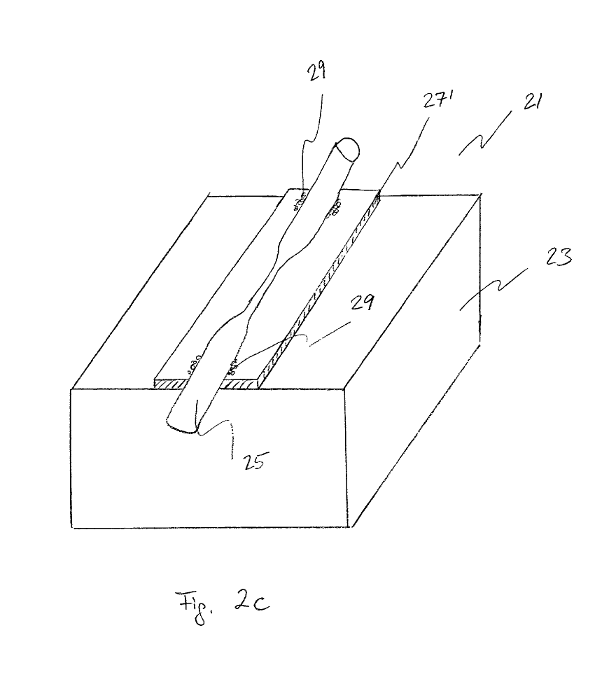

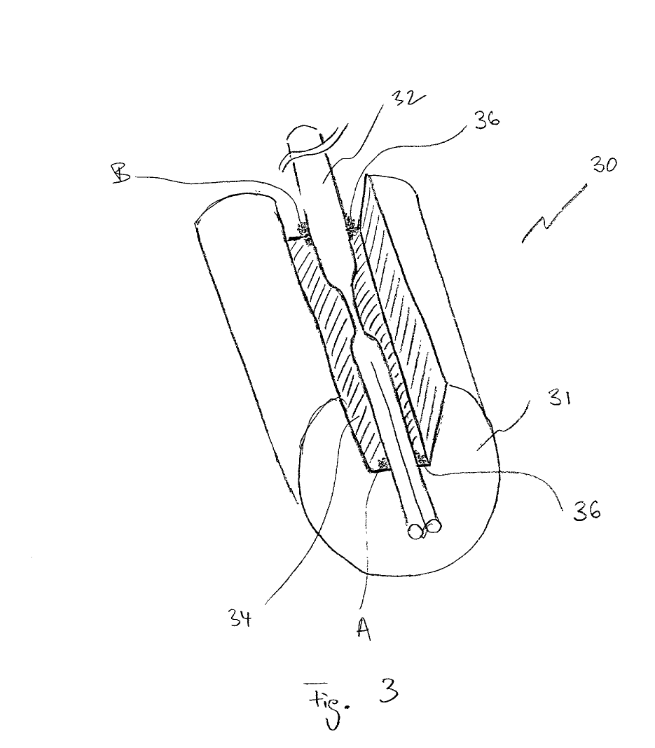

FIG. 2a shows an oblique view of an optical device 21 for supporting a tapered fiber in accordance with the invention. Optical device 21 is formed by providing a coating 27 to a surface of a stiff support/substrate 23. A tapered fiber 25 is disposed above coating 27 by placing the tapered fiber 25 on a spacer 29 such that the tapered fiber 25 is suspended over the substrate 23 having coasting 27 disposed thereon. Spacer 29 is in contact with non-tapered portions of tapered fiber 25 so as to suspend a tapered portion of tapered fiber 25 over substrate 23, as shown in FIG. 2a. The material used for spacer 29 is glass or glass frits, or alternatively an adhesive material, such as an epoxy material, is used for suspending the tapered fiber 25 over substrate 23. The use of an adhesive material provides an additional advantage of securing the tapered fiber 25 in a predetermined position over the coating 27 of substrate 23. In suspending the tapered portion of fiber 25 over the coating 27 of substrate 23, no excess slack is desired in accordance with the present invention.

FIG. 2b shows a schematic cross sectional side view of the optical device 21 shown in FIG. 2a to show more clearly how the tapered fiber 25 is suspended over the coating 27 of substrate 23. The placement of the tapered fiber 25 on spacer 29 creates a distance between the tapered fiber 25 and the coating 27 so that the tapered portion of fiber 25 is suspended over the coating 27.

FIG. 2c shows an oblique view of the optical device 21 shown in FIG. 2a in accordance with another embodiment wherein a coating 27′ is effected only on part of a surface of substrate 23. Again, the tapered fiber is suspended over the coating 27′ of substrate 23 by placing it on spacer/s 29.

A thickness of coating 27 or 27′ provided on at least one surface or part of the surface, respectively, of substrate 23 is determined by the amount of cushioning desired. It is apparent that a coating with a greater thickness provides more cushioning for the tapered fiber suspended thereover than a thin coating when the tapered fiber impacts with the coating 27/27′ of substrate 23. An average thickness of 10 μm was commonly used for coating 27/27′when preparing optical device 21. However, the present invention is not limited to this thickness as explained above. Nevertheless, the thickness of the polymer coating should be chosen so as not to change the dimension of the substrate.

The material used for the coating 27/27′ is a polymeric material, such as an epoxy, acrylate, polyurethane, and polyimide, or any other suitable polymer. Polymers have a good adhesive bond strength to the surface of substrate 23. Suitable materials for substrate 23 include stiff materials such as silicon (Si), silica (SiO₂), glass, quartz, NEOCERAM™, and invar. The polymeric materials suitable for use as coating 27/27′, have a much lower Young's modulus, i.e. a stretch modulus for solid materials, than the stiff materials suitable for use as substrate 23 and hence the amount of local force is reduced when the tapered fiber 25 impacts with a polymer coated surface of the substrate 23. Thus, optical device 21 has a greater resistance to cracks.

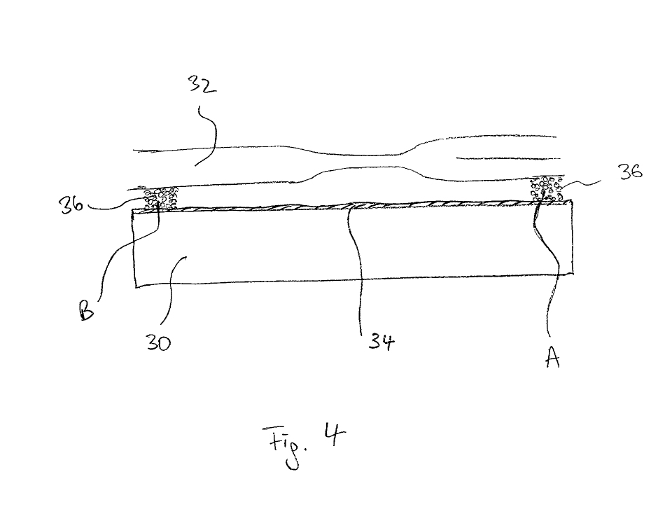

FIG. 3 shows an optical device 30, in accordance with another embodiment of the present invention, to rigidly support a fused tapered fiber 32. Optical device 30 is formed of a rod 31 having a receiving space in the form of a groove 34 provided along the entire length of rod 31. The fused tapered fiber 32 is placed in the groove 34 and suspended therein by a spacer or adhesive 36 so that the fused tapered fiber 32 does not touch the groove 34 of rod 31. In accordance with the present invention, groove 34 is coated with a polymer as indicated by the hatched lines. Spacer/adhesive 36 is applied at a position ‘A’ and a position ‘B’ within the groove 34 and the fused tapered fiber 32 is placed thereon. Both positions, ‘A’ and ‘B’, are chosen so as to avoid the fused tapered portion of fused tapered fiber 32.

FIG. 4 presents a schematic side view of the device shown in FIG. 3 to show more clearly how the fused tapered fiber 32 is suspended over the coated groove 34. In accordance with one embodiment of the invention, an epoxy material is used as the spacer/adhesive 36. As can be seen from FIGS. 3 and 4, the spacer/adhesive 36 is applied to a non-fused/non-tapered region of the fused tapered fiber 32. Again, the coated groove 34 provides a cushioning for the fused tapered fiber 32 when exposed to mechanical shock and vibrations. The polymer coating enhances the strength of the groove 34 and also prevents damage to the surface of the fused tapered fiber 32 as it impacts with the substrate due to mechanical shock and vibration. These impacts cause stresses which eventually lead to a breakage of the tapered fiber in the absence of a polymer coated substrate surface.

The thus prepared optical device 30 was subjected to evaluation tests to find that it was free from cracks and could withstand the impact tests undertaken.

When the tapered fiber 25 or the fused tapered fiber 32 impacts with the substrate surface during a shock test, a maximum shear stress occurs at a finite depth below the fiber surface. When the maximum shear stress exceeds the fiber strength, cracks are initiated immediately below the fiber surface. The cracks propagate when the external stress intensity exceeds the critical stress intensity of the tapered or fused tapered fiber. The propagation of the cracks eventually breaks the tapered or fused tapered fiber.

The following equation presents an example of how the maximum shear stress is calculated inside the fiber:

τₘₐₓ=0.24(F/d)^{0.5}[(1−υ₁²)/E₁+(1−υ₂²)/E₂]^{-0.5}

wherein F is a contact/normal force per unit length of the fiber and d is a diameter of the tapered fiber portion or region, υ₁ is Poisson's ratio of the tapered fiber, υ₂ is Poisson's ratio of the substrate, E₁ is Young's modulus of the tapered fiber, and E₂ is Young's modulus of the substrate.

With a silica substrate, for example, the calculated maximum shear stress of the fiber is 232.5 F^{0.5}, when d=0.04 mm, E₁=73,000 MPa for the fiber, E₂=73,000 MPa for the silica substrate, υ₁=0.165 for the fiber, and υ₂=0.165 for the silica substrate.

This shear stress is reduced by providing a polymer-coated substrate. For example, an epoxy coated silica substrate reduces the maximum shear stress in the fiber to 32.9 F^{0.5}, when d=0.04 mm, E₁=73,000 MPa for the fiber, E₂=690 MPa for the epoxy coating, υ₁=0.165 for the fiber, and υ₂=0.3 for the epoxy coating. This results in a maximum shear stress which is seven times lower than that experienced with the uncoated silica substrate. For a silica fiber with a typical shear strength of ˜100 MPa, the required contact force (F) to create cracks is 0.18 N/mm and 9.2 N/mm for the silica substrate and the epoxy-coated substrate, respectively. Thus, the maximum allowable impact force is increased up to 50 times with the epoxy-coated substrate.

The relationships presented below relate the above equation to the behavior of the device during mechanical shock.

When the tapered fiber impacts with the substrate, the velocity of the tapered fiber is related to the product of the acceleration and the duration of that acceleration in dependence on the geometry of the taper. This is a complicated relationship which is approximated as presented below.

$$If d > a \frac{t}{ω} ,$$

the fiber does not make an impact with the substrate, wherein d is the distance between the fiber and the substrate when the device is at rest, a is the acceleration of the shock, t is the duration of the shock, and ω is the angular frequency of small oscillations in the fundamental mechanical mode of the suspended tapered fiber.

However, if

$$d < a \frac{t}{ω} ,$$

the tapered fiber impacts with the substrate, then

v≅\sqrt{(a²t²−d²ω²)},

wherein v is an impact velocity.

The maximum force per unit length, f, of the fiber, for the two cases is approximated by

f∝\sqrt{E_{eff}ρ(a²t²−d²ω²)}

wherein ρ is a linear density of the fiber, i.e. mass per unit length of the fiber.

Thus, the maximum force per unit length, f, of the fiber is proportional to the square root of the effective Young's modulus, E_{eff}.

$${E}_{eff} ≅ {( \frac{1}{{E}_{fiber}} + \frac{1}{{E}_{substrate}} )}^{- 1}$$

The effective Young's modulus is approximated by one half the modulus of silica for the uncoated silica substrate, and by the modulus of the epoxy in the case of the coated substrate. Thus, for a given impact velocity v

$${f}_{uncoated} ≅ {f}_{coated} \sqrt{\frac{{E}_{silica}}{2 {E}_{epoxy}}}$$

Therefore, the above cited factor of 50 that relates the force damage threshold of the two cases and using the above cited values of Young's modulus, implies an approximate factor of:

$$50 \sqrt{\frac{\text{73,000}}{690}} = 360$$

of the velocity damage threshold ratio for the two cases.

This means, the epoxy coating allows the device to survive impacts with a velocity 360 times as large as in the uncoated case. In the case where the shock greatly exceeds the threshold for impact, this means that the ability to survive a shock acceleration-duration product is enhanced by a factor of greater than two orders of magnitude.

Advantageously, the polymer coating protects the tapered and/or fused fiber from damage and also preserves the optical performance of tapered and/or fused devices. Hence, the reliability of tapered and/or fused components is enhanced by coating the substrate with a polymer.

The term groove is used in this specification to denote a groove provided on a rod or a plate, or alternatively, a tube having a cut-out portion.

The coating of a groove surface in accordance with the invention is applicable to tapered and/or fused fibers to prevent adverse effects of mechanical shock or vibrations to the fibers. In some instances, optical fibers are provided with a taper in order to change the optical properties or transmission characteristics of the fiber. Both, tapered regions and fused fiber regions are similarly fragile. The fused fiber region is particularly vulnerable to environmental influences since the protective covering of the fiber was removed for the fusion process.

An alternative method of preventing flaws or damage of the fiber surface is to use shorter fused fibers, so that the fiber does not contact the surface of the groove during mechanical shock or vibration. However, this adversely affects the optical performance of such a device. Another method of protecting the fiber surface is to use large grooves so that the fiber can not reach the surface of the groove. However, this results in an increased package size of the optical device making it more bulky and expensive due to increased material costs. Furthermore, since the support structure that holds the fiber is larger and tends to move more with temperature variation, it may affect the temperature dependence of the optical performance of the packaged coupler.

Numerous other embodiments can be envisaged without departing from the spirit and scope of the invention.

What is claimed is:

1. An optical device comprising:
(a) a tapered optical fiber; and
(b) a substrate for supporting said optical fiber, wherein a surface of the substrate has an at least partial coating with a material for protecting the tapered optical fiber during an impact therewith.

2. The optical device as defined in claim 1 wherein the coating has a substantially lower Young's modulus than the substrate for reducing an amount of local force when the tapered optical fiber impacts with the coating.

3. The optical device as defined in claim 1 further including a spacer for suspending the tapered optical fiber over the at least partially coated substrate.

4. The optical device as defined in claim 3 wherein the spacer is adjacent to a substantially non-tapered portion of the tapered optical fiber.

5. The optical device as defined in claim 4 wherein the spacer is an adhesive for securing the tapered optical fiber in a predetermined position over the at least partially coated surface of the substrate.

6. The optical device as defined in claim 5 wherein the adhesive is an epoxy material.

7. The optical device as defined in claim 1 further including a receiving space on the substrate for supporting and positioning the tapered optical fiber therein, said receiving space including the at least partial coating.

8. The optical device as defined in claim 7 wherein the receiving space is a groove.

9. The optical device as defined in claim 1 wherein the material is a polymer.

10. The optical device as defined in claim 9 wherein the polymer is one of an epoxy, acrylate, polyurethane, and polyimide polymer.

11. The optical device as defined in claim 4 wherein the tapered optical fiber is a fused fiber.

12. The optical device as defined in claim 1 wherein the coating has a thickness for reducing a shear stress inside the tapered optical fiber.

13. The optical device as defined in claim 1 wherein the substrate is a stiff material selected from the group consisting of silicon (Si), silica (SiO₂), glass, quartz, Neoceram, and invar.

14. The optical device as defined in claim 1 wherein said tapered optical fiber is at least one of a single-mode fiber, a multimode fiber, a polarization-maintaining fiber, a hollow-core fiber, a gradient-index fiber, and a stepped-index fiber.

15. A support for a tapered optical fiber comprising:
a stiff substrate for supporting the tapered optical fiber, wherein a surface of the substrate has an at least partial coating with a polymeric material for protecting the tapered optical fiber during an impact therewith when the tapered optical fiber is suspended over the at least partially coated surface of the substrate.

16. The support as defined in claim 15 further including a spacer for suspending the tapered optical fiber over the at least partially coated surface of the substrate.

17. The support as defined in claim 16 wherein the spacer is an adhesive, said adhesive being adjacent to a substantially non-tapered portion of the tapered optical fiber.

18. The support as defined in claim 15 wherein the polymeric material is one of an epoxy, acrylate, polyurethane, and polyimide polymer.

19. The support as defined in claim 15 wherein the substrate includes a receiving space for supporting and positioning the tapered optical fiber therein, said receiving space including the at least partial coating.

20. An optical device comprising:
(a) a tapered optical fiber;
(b) a substrate for supporting said optical fiber, wherein a surface of the substrate has an at least partial coating with a polymeric material for protecting the tapered optical fiber during an impact therewith; and
(c) a spacer for suspending the tapered optical fiber over the at least partially coated substrate.
